(19) United States
(12) Patent Application Publication
(10) Pub. No.: US 2011/0235687 A1
(43) Pub. Date: Sep. 29, 2011

(54) SIGNAL ACQUISITION METHOD, SIGNAL ACQUISITION APPARATUS AND ELECTRONIC DEVICE

(75) Inventor: Shunichi Mizuochi, Matsumoto-shi (JP)

(73) Assignee: SEIKO EPSON CORPORATION, Shinjuku-ku (JP)

(21) Appl. No.: 13/070,393

(22) Filed: Mar. 23, 2011

(30) Foreign Application Priority Data
Mar. 24, 2010 (JP) 2010-067546

(51) Int. Cl. H04B 1/709

(52) U.S. Cl. 375/150; 375/E01.002

(57) ABSTRACT

A signal acquisition method includes: frequency-converting the frequency of a reception signal which is a satellite signal received from a positioning satellite into a specific frequency corresponding to a bit length of navigation message data carried by the satellite signal; performing a first correlation operation according to a signal of the frequency-converted specific frequency; integrating results of the first correlation operation over a predetermined time longer than the bit length; and acquiring the satellite signal using the integrated results.

### BACKGROUND

1. Technical Field

The present invention relates to a signal acquisition method, a signal acquisition apparatus and an electronic device.

2. Related Art

GPS (Global Positioning System) is widely known as a positioning system which uses a positioning signal, and is applied to a position calculation device built into a mobile phone, a car navigation apparatus, or the like. In GPS, a position calculation is performed for calculating the position coordinates of the position calculation device and the timepiece error, on the basis of information including positions of a plurality of GPS satellites, a pseudo distance from each GPS satellite to the position calculation device, and the like.

A GPS satellite signal transmitted from the GPS satellite is modulated using spread codes called CA (Coarse and Acquisition) codes, which differ according to each GPS satellite. In order to acquire the GPS satellite signal from weak received signals, the position calculation device performs a correlation operation of the received signals and replica CA codes which are replicas of the CA codes, and acquires the GPS satellite signal on the basis of the correlation values. In this case, in order to easily detect a peak of the correlation values, a technique is used in which the correlation values obtained by the correlation operation are integrated over a predetermined integration time.

However, since the CA codes which spread modulate the GPS satellite signal are BPSK (Binary Phase Shift Keying) modulated every 20 milliseconds by the navigation message data, the polarity of the CA codes may be inverted every 20 milliseconds, which is the bit length of the navigation message data. Thus, in a case where the correlation values are integrated over the timing when the bit value of the navigation message data is changed, there is a possibility that the correlation values having different signs are integrated. In order to solve this problem, a technique is known in which correlation values are integrated using assistance data with respect to the timing when the bit value of the navigation message data is changed, as disclosed in JP-A-2001-349935, for example.

According to JP-A-2001-349935, a correlation integration time can be set longer than the bit length (20 milliseconds) of the navigation message data. However, in the technique disclosed in JP-A-2001-349935, it is necessary to acquire the assistance data with respect to the timing when the bit value of the navigation message data is changed, from the outside, thereby causing restrictions or problems related to data acquisition such as a problem of communication cost or communication time. In particular, after the navigation message data transmitted from the GPS satellite signal is switched to new data, it is necessary to wait for an update of the assistance data and to acquire the new assistance data.

### SUMMARY

An advantage of some aspects of the invention is that it provides a new technique which is capable of performing a correlation process over a correlation integration time longer than the bit length of the navigation message data.

According to a first aspect of the invention, there is provided a signal acquisition method including: a frequency-converting frequency of a reception signal which is a satellite signal received from a positioning satellite into a specific frequency corresponding to a bit length of the navigation message data carried by the satellite signal; performing a first correlation operation according to a signal of the frequency-converted specific frequency; integrating the results of the first correlation operation over a predetermined time longer than the bit length; and acquiring the satellite signal using the integrated results.

Further, according to a fifth aspect of the invention, there may be provided a signal acquisition apparatus including: a receiving section which receives a satellite signal from a positioning satellite; a frequency converting section which converts the frequency of a reception signal which is received by the receiving section into a specific frequency corresponding to a bit length of the navigation message data carried by the satellite signal; a correlation operating section which performs a correlation operation according to a signal of the specific frequency frequency-converted by the frequency converting section; an integrating section which integrates the results of the correlation operation over a predetermined time longer than the bit length; and an acquiring section which acquires the satellite signal using the correlation operation results integrated by the integrating section.

According to the first aspect, the frequency of the reception signal which is the satellite signal received from the positioning satellite is frequency-converted into the specific frequency corresponding to the bit length of the navigation message data carried by the satellite signal.

Further, the first correlation operation is performed according to the signal of the frequency-converted specific frequency, and the results of the first correlation operation are integrated over the predetermined time longer than the bit length of the navigation message data. Then, the satellite signal is acquired using the integrated results.

In a case where a correlation process is performed for the reception signal of the satellite signal carried by the navigation message data over an arbitrary time longer than the bit length of the navigation message data, even though the acquisition is performed according to a correct frequency, time series data on correlation values having a sign change is obtained. However, it has been discovered through experiments that if the acquisition is performed for the signal of the specific frequency corresponding to the bit length of the navigation message data, the time series data on the correlation values having a sign change pattern different from the case where the acquisition is performed for a correct frequency is obtained. This time series data on the correlation values having the different sign change pattern is obtained by frequency-converting the frequency of the reception signal into the specific frequency and performing the correlation operation according to the signal of the specific frequency. By integrating the correlation operation results on the basis of the time series data of the correlation values obtained in this way and acquiring the satellite signal using the integration result, it is possible to perform the correlation process over a correlation integration time longer than the bit length of the navigation message data.

According to a second aspect of the invention, the signal acquisition method in the first aspect may further include: frequency-converting the frequency of the reception signal into a zero frequency; performing a second correlation operation according to a signal of the frequency-converted zero frequency; and integrating the results of the second correlation operation over the predetermined time, and the satellite signal may be acquired using a combination value obtained by combining a result obtained by integrating the results of the first correlation operation and a result obtained by integrating the results of the second correlation operation, in the satellite signal acquisition.

According to the second aspect, the frequency of the reception signal is frequency-converted into the zero frequency. Further, the second correlation operation is performed according to the signal of the frequency-converted zero frequency and the results of the second correlation operation are integrated over the predetermined time. Then, the result obtained by integrating the results of the first correlation operation and the result obtained by integrating the results of the second correlation operation are combined, and the satellite signal is acquired using the combination value. As the correlation operation result for the signal of the zero frequency is added to the correlation operation result for the signal of the specific frequency, it is possible to reduce the effect of bit inversion of the navigation message data and to perform a correlation process over an arbitrary correlation integration time.

Further, according to a third aspect of the invention, the signal acquisition method in the first aspect may further include: frequency-converting the frequency of the reception signal into a zero frequency; performing a second correlation operation according to a signal of the frequency-converted zero frequency; and integrating the results of the second correlation operation over the predetermined time, and the satellite signal may be acquired using either one of a result obtained by integrating the results of the first correlation operation and a result obtained by integrating the results of the second correlation operation, in the satellite signal acquisition.

According to the third aspect, the frequency of the reception signal is frequency-converted into the zero frequency. Further, the second correlation operation is performed according to the signal of the frequency-converted zero frequency and the results of the second correlation operation are integrated over the predetermined time. Then, the satellite signal is acquired using either one of the result obtained by integrating the results of the first correlation operation and the result obtained by integrating the results of the second correlation operation. For example, by using the result having a large value among the result obtained by integrating the results of the first correlation operation and the result obtained by integrating the results of the second correlation operation, it is possible to appropriately acquire the satellite signal.

Further, according to a fourth aspect of the invention, in the signal acquisition method in the first to third aspects, the specific frequency may be 25 Hz. The specific frequency in this case is a frequency corresponding to a case where the bit length of the navigation message data is 20 milliseconds.

Further, according to a sixth aspect of the invention, there may be provided an electronic device including the signal acquisition apparatus in the fifth aspect.

### BRIEF DESCRIPTION OF THE DRAWINGS

The invention will be described with reference to the accompanying drawings, wherein like numbers reference like elements.

FIG. 1A is an example of a time change in correlation values and FIG. 1B is an example of a frequency analysis result.

FIGS. 2A and 2B illustrate direct-current components of correlation values, and FIG. 2C illustrates specific frequency components of correlation values.

FIG. 3A illustrates a zero frequency signal in a case where there is no bit inversion of navigation message data and

FIG. 3B illustrates a zero frequency signal in a case where there is bit inversion of navigation message data.

FIG. 4A illustrates a specific frequency signal in a case where there is no bit inversion of navigation message data and FIG. 4B illustrates a specific frequency signal in a case where there is bit inversion of navigation message data.

FIG. 5 is a block diagram illustrating an example of a functional configuration of a mobile phone.

FIG. 6 is a block diagram illustrating an example of a circuit configuration of a baseband processing circuit section.

FIG. 7 is a flowchart illustrating the work flow of a baseband process.

FIG. 8 is a flowchart illustrating the work flow of a correlation process.

FIG. 9 is a diagram illustrating an example of a result of a correlation process in a phase direction and in a frequency direction in the related art.

FIG. 10 is a diagram illustrating an example of a result of a correlation process in a frequency direction in the related art.

FIG. 11 is a diagram illustrating an example of a result of a correlation process in a phase direction in the related art.

FIG. 12 is a diagram illustrating an example of a result of a correlation process in a phase direction and in a frequency direction in the related art.

FIG. 13 is a diagram illustrating an example of a result of a correlation process in a frequency direction in the related art.

FIG. 14 is a diagram illustrating an example of a result of a correlation process in a phase direction in the related art.

FIG. 15 is a diagram illustrating an example of a result of a correlation process in a phase direction and in a frequency direction according to an embodiment.

FIG. 16 is a diagram illustrating an example of a result of a correlation process in a frequency direction according to an embodiment.

FIG. 17 is a diagram illustrating an example of a result of a correlation process in a phase direction according to an embodiment.

FIG. 18 is a diagram illustrating an example of a result of a correlation process in a phase direction and in a frequency direction according to an embodiment.

FIG. 19 is a diagram illustrating an example of a result of a correlation process in a frequency direction according to an embodiment.

FIG. 20 is a diagram illustrating an example of a result of a correlation process in a phase direction according to an embodiment.

FIG. 21 is a block diagram illustrating a circuit configuration of a baseband processing circuit section according to a modification.

FIG. 22 is a diagram illustrating a data configuration of a storing section of a baseband processing circuit section according to a modification.

### DESCRIPTION OF EXEMPLARY EMBODIMENTS

### 1. Principle

Firstly, the principle of satellite signal acquisition according to the present embodiment will be described.

In a position calculation system using a GPS satellite, the GPS satellite which is a type of positioning satellite transmits navigation message data including satellite orbit data, such as an almanac or an ephemeris, through a GPS satellite signal which is a type of positioning satellite signal.

The GPS satellite signal is a communication signal of 1.57542 GHz modulated by CDMA (Code Division Multiple Access) which is known as a spectrum spread technique, using CA (Coarse and Acquisition) codes which are a type of spread code. The CA codes are pseudo random noise codes in a repetitive cycle of 1 ms in which a code length of 1023 chips is set to one PN frame, which differ according to each satellite.

The frequency (regulated carrier frequency) at the time when the GPS satellite transmits the GPS satellite signal is regulated in advance as 1.57542 GHz. However, due to the Doppler effect or the like generated by the movement of the GPS satellite or a GPS receiver, the frequency at the time when the GPS receiver receives the GPS satellite signal does not necessarily coincide with the regulated carrier frequency. Thus, the GPS receiver in the related art performs a frequency search which is a correlation operation in a frequency direction for acquiring the GPS satellite signal from received signals to acquire the GPS satellite signal. Further, in order to specify the phase of the received GPS satellite signal (CA codes), the GPS receiver performs a phase search which is a correlation operation in a phase direction to acquire the GPS satellite signal.

However, in particular, in a weak electric field environment such as an indoor environment, since the level of a correlation value in a true reception frequency and a true code phase is lowered, it is difficult to distinguish it from noise. As a result, detection of the true reception frequency and the true code phase, that is, signal acquisition, becomes difficult. Thus, in such a reception environment, a technique is used in which correlation values obtained by the correlation operation are integrated over a predetermined correlation integration time and a peak is detected from the integrated correlation values to acquire the GPS satellite signal.

However, the GPS satellite signal is spread modulated by the CA codes, and the CA codes are BPSK (Binary Phase Shift Keying) modulated according to a bit value of the navigation message data. Since the bit length of the navigation message data is 20 milliseconds, there is a possibility that the bit value is changed (inverted) every 20 milliseconds. The possibility means that the bit value may not necessarily be changed. In this embodiment, the timing when the bit value of the navigation message data is actually changed is referred to as “bit inversion timing”.

That the bit value of the navigation message data is changed means that the polarity of the CA codes is inverted. Thus, if a correlation operation of the received CA codes and replica codes is performed, correlation values having different signs can be calculated every 20 milliseconds which is the bit length of the navigation message data. Accordingly, if the correlation values are integrated over the bit inversion timing of the navigation message data, correlation values having different signs are offset against each other, and thus, a problem where the correlation values become significantly small (in an extreme case, 0) occurs. In order to solve this problem, the present inventor contrived a new technique of negating the affect of a sign change in the correlation values, in consideration of the specific frequency corresponding to the bit length of the navigation message data, and of integrating the correlation values.

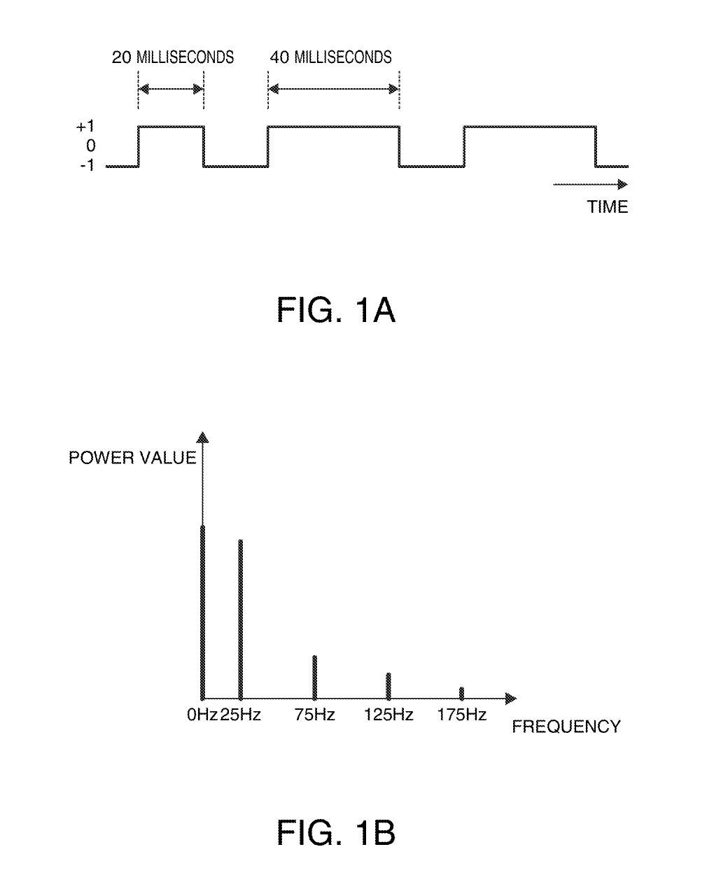

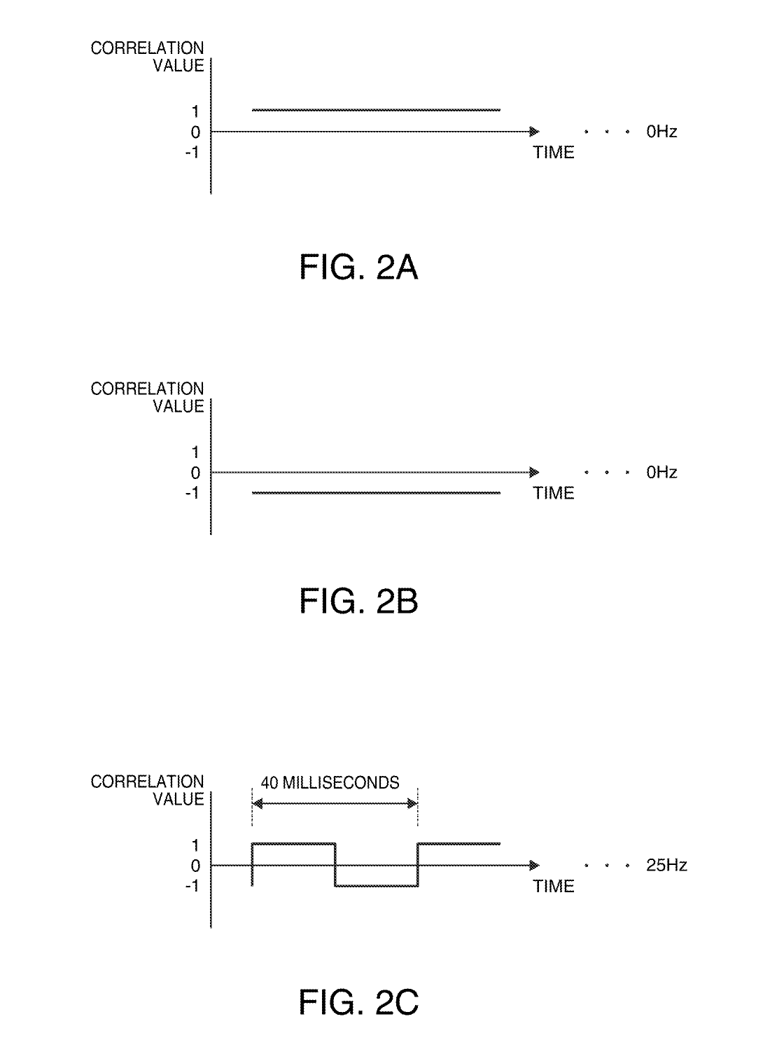

FIGS. 1A and 1B and FIGS. 2A to 2C are diagrams illustrating a specific frequency. FIG. 1A illustrates an example of a time-series change in correlation values. For ease of description, the correlation values are expressed as two positive and negative values, “+1” and “−1”. Further, a case where a true value of a reception frequency is already known and a correlation operation is performed using replica codes which coincide with the received CA codes in phase to calculate the correlation values, will be described hereinafter.

If the polarity of the CA code in a case where the bit value of the navigation message data is “1” is positive, the received CA code is multiplied by the replica code, and thus, the correlation value “+1” is obtained. On the other hand, if the polarity of the CA code in a case where the bit value of the navigation message data is “0” is negative, the received CA code is multiplied by the replica code, and thus, the correlation value “−1” is obtained.

Referring to FIG. 1A, it can be understood that the signs of the correlation values are switched at the bit inversion timing of the navigation message data. In a case where the bit inversion timing comes after 20 milliseconds from the previous bit inversion timing, according to the bit value, the sign of the correlation value is inverted at the timing after 20 milliseconds. Further, in a case where the bit inversion timing comes after 40 milliseconds, the sign of the correlation value is inverted at the timing after 40 milliseconds.

If the time-series correlation values shown in FIG. 1A are accumulated over a predetermined time which is longer than the bit length and the frequency analysis is performed, a power spectrum as shown in FIG. 1B is obtained, for example.

In FIG. 1B, the transverse axis represents the frequency, and the longitudinal axis represents a power value. For ease of description, white noise is not shown.

As shown in FIG. 1B, a peak of a power value appears in a zero frequency (0 Hz). This indicates the direct-current components of the time-series correlation values. That is, as shown in FIGS. 2A and 2B, the frequency components (direct-current components) corresponding to a portion where the sign is not changed, among the time-series correlation values, appear as the peak of the power value of 0 Hz.

However, as shown in FIG. 1B, a peak having a large power value also appears in a frequency of 25 Hz. This is caused by the fact that the bit length of the navigation message data is 20 milliseconds. That is, as shown in FIG. 2C, in a case where the bit value of the navigation message data is changed every 20 milliseconds, for example, since the correlation values are changed to “1” in initial 20 milliseconds, “−1” in the next 20 milliseconds, and “1” in the second next 20 milliseconds, the cycle of the correlation values becomes 40 milliseconds.

The period of 40 milliseconds is a period corresponding to two times the bit length of the navigation message data. If the cycle of 40 milliseconds is converted into a frequency, “f=1/T=1/(40×10⁻³)=25 Hz”. Frequency components of 25 Hz included in the time-series correlation values appear as the peak of the power value. In this embodiment, the frequency of 25 Hz is defined as a “specific frequency”.

Further, referring to FIG. 1B, it can be understood that small peaks, which are not as large as the specific frequency (25 Hz), appear in higher frequencies such as 75 Hz, 125 Hz and 175 Hz. A waveform of the correlation values is symmetric, and thus, the peak of the power value appears in the frequency of an odd multiple of the specific frequency which is a fundamental frequency, that is, in the odd-order harmonic frequency.

The peak of the power values is caused by the fact that the polarity of the CA code is inverted at the bit inversion timing of the navigation message data and the sign of the correlation value is changed. For example, in a case where the frequency analysis is performed by setting the integration time of the correlation values to equal to or shorter than 20 milliseconds of the bit length in order not to exceed the bit inversion timing, the peak appears only at the zero frequency and the peak does not appear in other frequencies. That is, if the sign of the correlation value is not changed, the peak of the power value does not appear in frequencies other than the zero frequency.

The inventor focused on the fact that in a case where the correlation process is performed over an arbitrary time which is longer than the bit length of the navigation message data as described above, the peak of the power value appears in the zero frequency (0 Hz) and the specific frequency (25 Hz). Further, the inventor considered that the frequency of a reception signal which is the GPS satellite signal is frequency-converted into a frequency corresponding to a zero frequency (a reception signal of this frequency is referred to as a “zero frequency signal”) and a frequency corresponding to a specific frequency (a reception signal of this frequency is referred to as a “specific frequency signal”), respectively, to thereby acquire the GPS satellite signal using the correlation operation result for the respective signals.

In this embodiment, it is assumed that only a positive frequency is considered while a negative frequency is not considered, for ease of description.

Hereinafter, detailed descriptions will be made. A reception signal “r(t)” of the GPS satellite signal which is received by the GPS receiver at a time “t” can be expressed by the following formula (1).

$$\begin{matrix}r ( t ) = I ( t ) + i Q ( t ) \\ = CA ( t ) \cdot {e}^{iω t}\end{matrix} \qquad ( 1 )$$

In the formula (1), “I(t)” and “Q(t)” are I and Q components of the reception signal “r(t)”, respectively. The I component represents the same phase component (real part) of the reception signal and the “Q” component represents a perpendicular component (imaginary part) of the reception signal. Further, “CA(t)” represents the CA codes of the received GPS satellite signal (hereinafter, referred to as “received CA codes”), which is a value of “+1” or “−1”. In addition, “exp(iωt)” represents a carrier which transports the GPS satellite signal.

Further, in the formula (1), “ω” is a reception frequency in which the GPS satellite signal is received, which is expressed by the following formula (2).

ω=ω_{c}+ω_{d} (2)

Here, “ω_{c}” represents a carrier frequency of the GPS satellite signal, and “ω_{d}” represents a Doppler frequency.

If a signal having a frequency which differs by “Δω” from a frequency “ω” of the carrier “exp(iωt)” is multiplied by the reception signal “r(t)” of the GPS satellite signal, the reception signal is converted into a signal “r(t, Δω)=CA(t)·exp(iΔωt)”. In this embodiment, “Δω” is defined as a “frequency shift”.

If there is no frequency shift (Δω=0), the frequency of the reception signal is converted into the zero frequency “r(t, 0)=CA(t)”. That is, this means demodulation for the received CA codes. On the other hand, if the frequency shift is equivalent to a specific frequency “ωₛ” (Δω=ωₛ), the frequency of the reception signal is converted into a specific frequency “r(t, ωₛ)=CA(t)·exp(iωₛt)”.

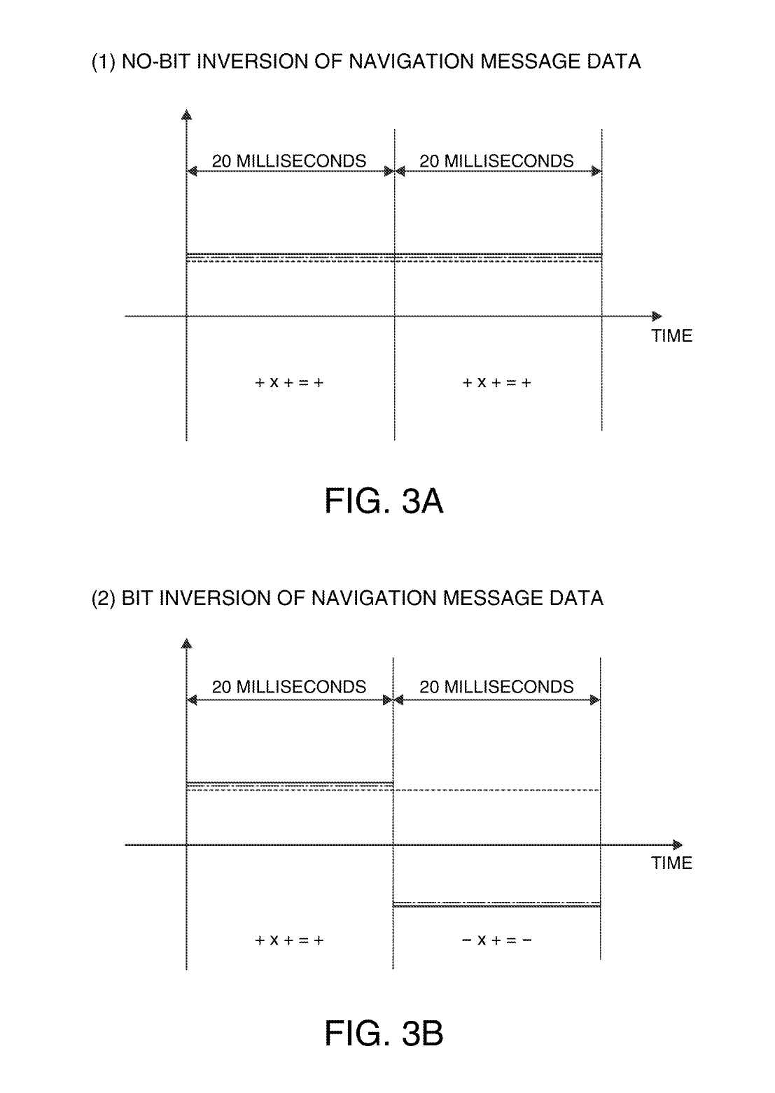

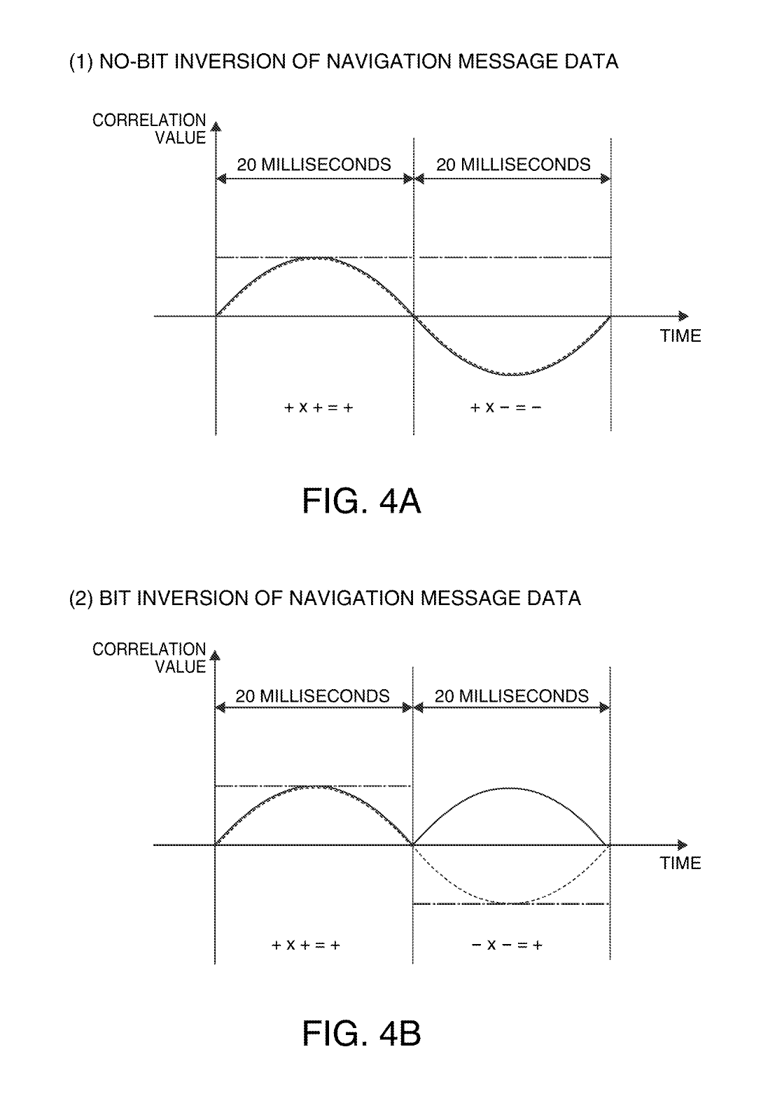

FIGS. 3A and 3B are diagrams illustrating the zero frequency signal “r(t, 0)”. In FIGS. 3A and 3B, the transverse axis represents time. Here, in consideration of the period of two bit lengths (40 milliseconds) of the navigation message data, the received CA codes “CA(t)” are indicated by a dashed line, a term indicating the carrier of the zero frequency “exp(iΔωt)” is indicated by a dotted line, and the zero frequency signal “r(t, 0)” is indicated by a solid line, respectively. In FIGS. 3A and 3B, and FIGS. 4A and 4B, the respective lines are appropriately shifted, for ease of understanding.

FIG. 3A is a diagram illustrating a case where the bit value of the navigation message data is not inverted at 20 milliseconds. In a case where the received CA codes are the positive polarity during the initial 20 milliseconds, if the bit value of the navigation message data is not changed at the timing after the 20 milliseconds elapses, the polarity of the received CA codes is not changed while maintaining the positive value. Further, since the frequency shift is “0 Hz”, the carrier is removed and “exp(i·0·t)=1”. Thus, the polarity of the zero frequency signal “r(t, 0)” becomes positive through the period of the 40 milliseconds. If the replica codes of the positive polarity are multiplied by the zero frequency signal “r(t, 0)”, positive correlation values are obtained through the period of the 40 milliseconds.

FIG. 3B is a diagram illustrating a case where the bit value of the navigation message data is inverted during the 20 milliseconds. If the bit value of the navigation message data is changed at the timing after the 20 milliseconds elapses, the polarity of the received CA codes is changed and becomes a negative polarity. Thus, the polarity of the zero frequency signal “r(t, 0)” becomes positive in the initial 20 milliseconds and becomes negative in the next 20 milliseconds. If the replica codes of the positive polarity are multiplied by the zero frequency signal “r(t, 0)”, positive correlation values are obtained in the initial 20 milliseconds and negative correlation values are obtained in the next 20 milliseconds.

FIGS. 4A and 4B are diagrams illustrating the specific frequency signal “r(t, ωₛ)”. The perspective in the figure is the same as FIGS. 3A and 3B. The received CA codes “CA(t)” are indicated by a dashed line, a term indicating the carrier of the specific frequency “exp (iωt)” is indicated by a dotted line, and the specific frequency signal “r(t, ωₛ)” is indicated by a solid line, respectively.

FIG. 4A is a diagram illustrating a case where the bit value of the navigation message data is not inverted during the 20 milliseconds. In a similar way to FIG. 3A, the polarity of the received CA codes is not changed at the timing after the 20 milliseconds elapses, and becomes the positive polarity through the period of the 40 milliseconds. Further, since the frequency shift is “25 Hz” which is the specific frequency, the term indicating the carrier is expressed as a sin wave of the frequency of 25 Hz. Thus, the polarity of the specific frequency signal “r(t, ωₛ)” becomes positive in the initial milliseconds and becomes negative in the next 20 milliseconds. If the replica codes of the positive polarity are multiplied by the specific frequency signal “r(t, ωₛ)”, positive correlation values are obtained in the initial 20 milliseconds and negative correlation values are obtained in the next 20 milliseconds.

FIG. 4B is a diagram illustrating a case where the bit value of the navigation message data is inverted during the 20 milliseconds. In a similar way to FIG. 3B, the polarity of the received CA codes is changed from positive to negative at the timing after the 20 milliseconds elapses. Further, the term indicating the carrier is expressed as a sin wave of the frequency of 25 Hz. Thus, the polarity of the specific frequency signal “r(t, ωₛ)” becomes positive in the initial 20 milliseconds and also becomes positive in the next 20 milliseconds. If the replica codes of the positive polarity are multiplied by the specific frequency signal “r(t, ωₛ)”, positive correlation values are obtained through the period of the 40 milliseconds.

As described above, it can be seen that the correlation operation (first correlation operation) result for the specific frequency signal and the correlation operation (second correlation operation) result for the zero frequency signal show opposite characteristics with respect to the influence of the bit inversion of the navigation message data. In other words, it can be said that the time-series data on the correlation values for the specific frequency signal and the time-series data on the correlation values for the zero frequency signal are data in which a sign change type (sign change pattern) due to the presence or absence of the bit inversion of the navigation message data is inverted.

In this embodiment, in consideration of this characteristic, a result obtained by integrating the correlation operation result for the specific frequency signal is combined by a result obtained by integrating the correlation operation result for the zero frequency signal, so that the GPS satellite signal is acquired on the basis of the combined integration correlation value obtained as the result. That is, a process of calculating the combined integration correlation value while changing the phase of the replica code is performed, and the phase of the replica code in which the combined integration correlation value becomes the maximum is detected, to thereby acquire the GPS satellite signal.

In this case, since the time-series data on the correlation values in which the sign change pattern is inverted is overlapped, it is possible to negate the influence of the bit inversion of the navigation message data. The reason is that the bit inversion of the navigation message data may be present or not, but since any one of the time-series data on the correlation values becomes data with a sign, if the correlation values are integrated, the values become large. Thus, even though the values become small in a case where a sign of the other time-series data on the correlation values is not provided and the correlation values are integrated, the values become large as the combined integration correlation value. According to the above-described principle, it is possible to integrate the correlation values over the correlation integration time which is longer than the bit length of the navigation message data.

### 2. Embodiments

Next, embodiments in a case where the invention is applied to a mobile phone which is a type of electronic device including a satellite signal acquisition device (signal acquisition device) and a positioning calculation device will be described. It is obvious that embodiments to which the invention can be applied are not limited to the following embodiments.

### 2-1. Functional Configuration

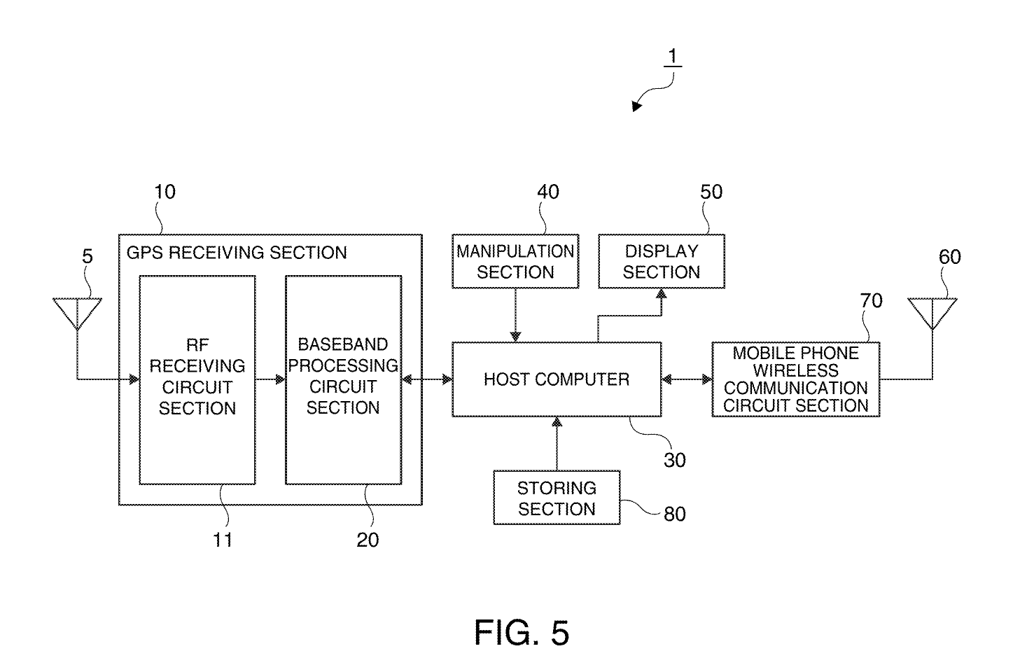

FIG. 5 is a block diagram illustrating an example of a functional configuration of a mobile phone 1 in each embodiment. The mobile phone 1 includes a GPS antenna 5, a GPS receiving section 10, a host CPU (Central Processing Unit) 30, a manipulation section 40, a display section 50, a mobile phone antenna 60, a mobile phone wireless communication circuit section 70, and a storing section 80.

The GPS antenna 5 receives an RF (Radio Frequency) signal including a GPS satellite signal transmitted from the GPS satellite, and outputs the received signal to the GPS receiving section 10.

The GPS receiving section 10 is a position calculation circuit or a position calculation device which measures the position of the mobile phone 1 on the basis of the signal output from the GPS antenna 5, which is a functional block corresponding to a so-called GPS receiver. The GPS receiving section 10 includes an RF receiving circuit section 11 and a baseband processing circuit section 20. The RF receiving circuit section 11 and the baseband processing circuit section 20 may be manufactured as different LSIs (Large Scale Integration) or as one chip.

The RF receiving circuit section 11 is a circuit which receives an RF signal. For example, a receiving circuit which converts the RF signal output from the GPS antenna 5 into a digital signal by an A/D converter and processes the digital signal may be used as the circuit configuration. Further, a configuration may be used in which the RF signal output from the GPS antenna 5 is processed as an analog signal as it is and is finally A/D converted, and then the digital signal is output to the baseband processing circuit section 20.

In the latter case, for example, it is possible to configure the RF receiving circuit section 11 as follows. That is, a predetermined oscillation signal is frequency-divided or frequency-multiplied, to generate an oscillation signal of RF signal multiplication. Then, the RF signal output from the GPS antenna 5 is multiplied by the generated oscillation signal to be down-converted into a signal of an intermediate frequency (hereinafter, referred to as an IF (Intermediate Frequency) signal). Then, the IF signal undergoes amplification and the like, is converted into a digital signal by the A/D converter, and then is output to the baseband processing circuit section 20.

The baseband processing circuit section 20 is a processing circuit block which performs a correlation process or the like for the received signal output from the RF receiving circuit section 11 to acquire the GPS satellite signal, and performs a predetermined position calculation on the basis of satellite orbit data, time data and the like extracted from the GPS satellite signal to calculate the position (position coordinates) of the mobile phone 1. The baseband processing circuit section 20 functions as the satellite signal acquisition device which acquires the GPS satellite signal from the received signals.

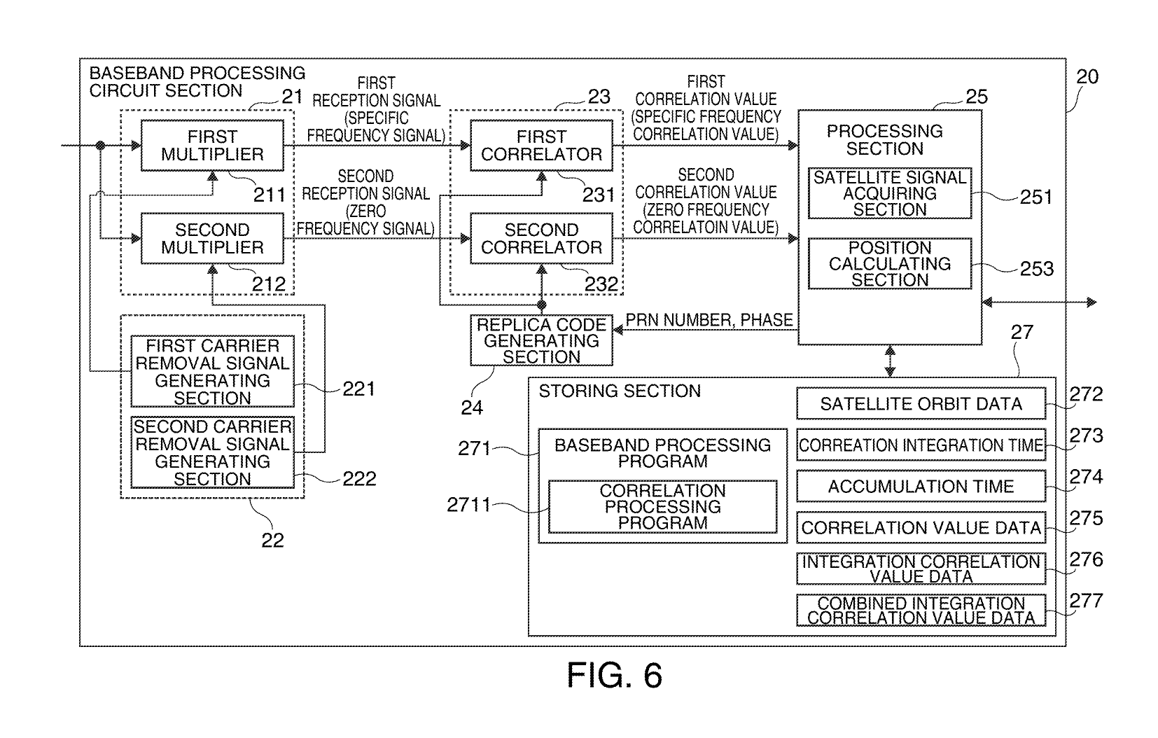

FIG. 6 is a diagram illustrating an example of a circuit configuration of the baseband processing circuit section 20, which mainly illustrates a circuit block according to this embodiment. For example, the baseband processing circuit section 20 includes a multiplying section 21 including a first multiplier 211 and a second multiplier 212, a carrier removal signal generating section 22 including a first carrier removal signal generating section 221 and a second carrier removal signal generating section 222, a correlating section 23 including a first correlator 231 and a second correlator 232, a replica code generating section 24, a processing section 25, and a storing section 27.

The first multiplier 211 multiplies the received signal by a first carrier removal signal generated by the first carrier removal signal generating section 221, and down-converts the received signal into a first reception signal (specific frequency signal) which is a signal of the specific frequency to thereby output the result to the first correlator 231. The first multiplier 211 may be a frequency converting section (first converting section) which frequency-converts the frequency of the received signal to the specific frequency corresponding to the bit length of the navigation message data.

The first carrier removal signal generating section 221 is a circuit which generates a first carrier removal signal in which frequency-shifts by the specific frequency from the frequency of the carrier signal of the GPS satellite signal, and includes an oscillator such as a carrier NCO (Numerical Controlled Oscillator) or the like, for example. In a case where the signal output from the RF receiving circuit section 11 is the IF signal, the signal which shifts by the specific frequency from the IF frequency may be generated. In this way, in a case where the RF receiving circuit section 11 down-converts the reception signal into the IF signal, the present embodiment can be applied thereto substantially in the same manner.

The second multiplier 212 multiplies the received signal by a second carrier removal signal generated by the second carrier removal signal generating section 222, and down-converts the received signal into a second reception signal (zero frequency signal) which is a signal of the zero frequency to thereby output the result to the second correlator 232. The second multiplier 212 may be a frequency converting section (second converting section) which frequency-converts the frequency of the received signal to the zero frequency.

The second carrier removal signal generating section 222 is a circuit which generates a second carrier removal signal having the same frequency as the frequency of the carrier signal of the GPS satellite signal, and includes an oscillator such as a carrier NCO or the like, for example. In a case where the signal output from the RF receiving circuit section 11 is the IF signal, the signal of the IF frequency may be generated.

The first correlator 231 performs a correlation operation of a first reception signal output from the first multiplier 211 and a replica code generated by the replica code generating section 24, which corresponds to a correlation operating section (first correlation operating section) which outputs the first correlation value (specific frequency correlation value) which is a correlation value of the specific frequency to the processing section 25.

The second correlator 232 performs a correlation operation of a second reception signal output from the second multiplier 212 and a replica code generated by the replica code generating section 24, which corresponds to a correlation operating section (second correlation operating section) which outputs the second correlation value (zero frequency correlation value) which is a correlation value of the zero frequency to the processing section 25.

The replica code generating section 24 is a circuit section which generates the replica codes (replica CA codes) obtained by copying the CA codes which are the spread codes of the GPS satellite signal, and for example, includes an oscillator such as a code NCO or the like. The replica code generating section 24 generates the replica codes according to a PRN number (satellite number) instructed from the processing section 25, by adjusting the output phase (time) according to an instructed phase, and outputs the generated replica codes to the correlating section 23.

The correlating section 23 (first and second correlators 231 and 232) performs the correlation operation of the respective “I” and “Q” components of the received signal and the replica codes input from the replica code generating section 24. A circuit block which performs the separation of the I and Q components (IQ separation) of the received signal is not shown, and may have a variety of configurations. For example, when the received signal is down-converted into the IF signal in the RF receiving circuit section 11, the IQ separation may be performed by multiplying the received signal by a local oscillation signal having a different phase of 90 degrees.

The processing section 25 is a control device which controls the respective functional sections of the baseband processing circuit section 20 overall, and includes a processor such as a CPU, for example. The processing section 25 functions as an integrating section which integrates the result of the correlation operation output from the correlating section 23, and as an acquiring section which acquires the GPS satellite signal using the integrated correlation operation result. As the main functional sections, the processing section 25 includes a satellite signal acquiring section 251 and a position calculating section 253.

The satellite signal acquiring section 251 integrates the first correlation values output from the first correlator 231 and the second correlation values output from the second correlator 232 over a predetermined correlation integration time, respectively, and acquires the GPS satellite signal on the basis of the combined integration correlation value of the first and second correlation values.

The position calculating section 253 is a calculating section which calculates the position of the mobile phone 1 by performing the known position calculation using the GPS satellite signal acquired by the satellite signal acquiring section 251, which outputs the calculated position to the host CPU 30.

The storing section 27 includes storage devices (memory) such as a ROM (Read Only Memory), a flash ROM, a RAM (Random Access Memory), and stores a system program of the baseband processing circuit section 20, or various programs, data or the like for realizing a variety of functions such as a satellite signal acquisition function, a position calculation function or the like. Further, the storing section 27 includes a work area in which the data being processed in a variety of processes, processed results, and the like are temporarily stored.

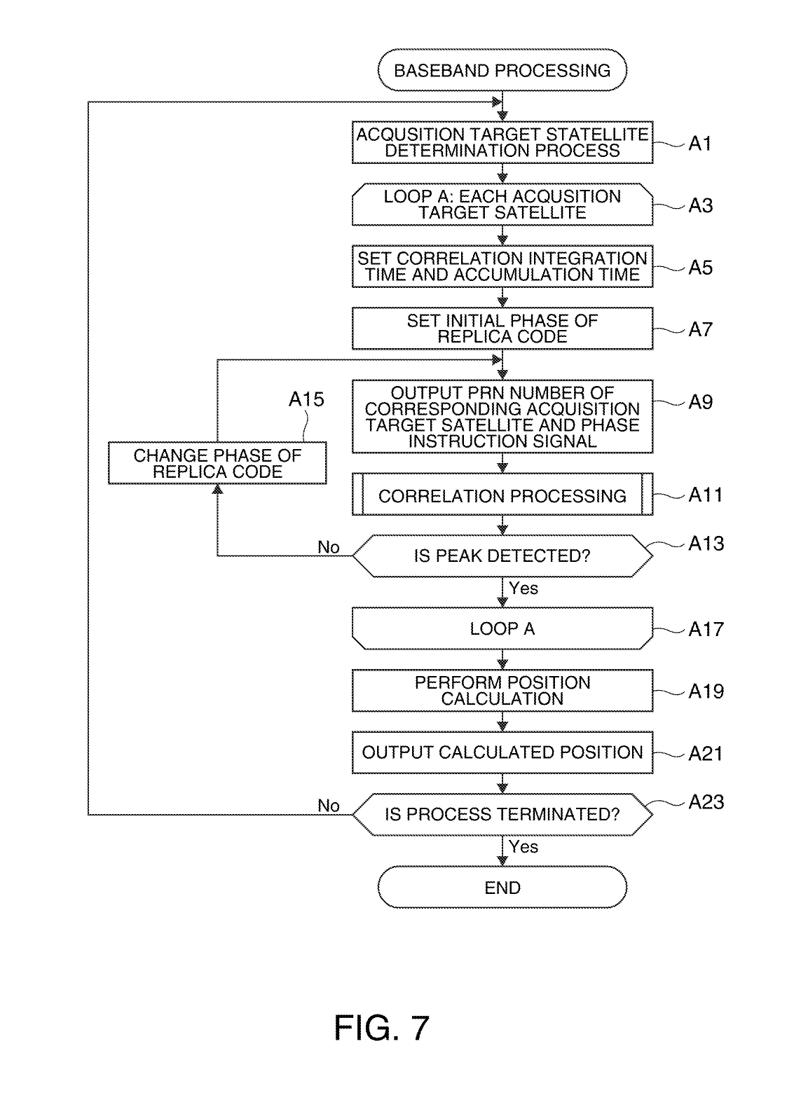

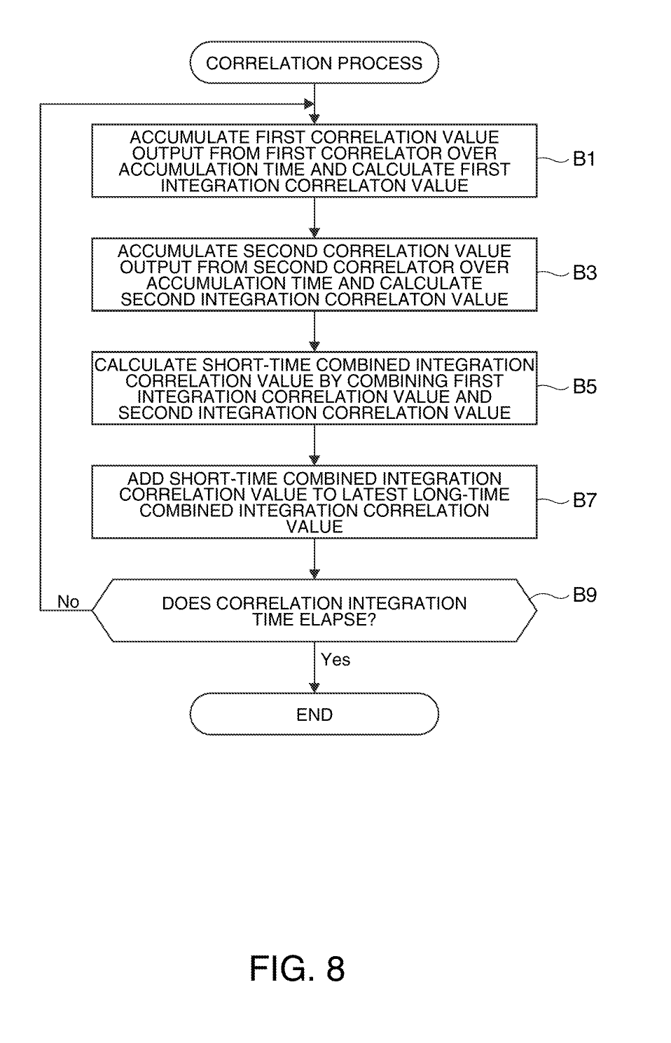

For example, as shown in FIG. 6, a baseband processing program 271 which is read out by the processing section 25 as a program and is executed as a baseband processing (see FIG. 7) is stored in the storing section 27. The baseband processing program 271 includes a correlation processing program 2711 executed as a correlation processes (see FIG. 8) as a sub-routine.

Further, as the temporarily stored data, for example, satellite orbit data 272, a correlation integration time 273, an accumulation time 274, correlation value data 275, integration correlation value data 276 and combined integration correlation value data 277 are stored in the storing section 27.

The baseband processing is a process in which the processing section 25 performs the correlation process with respect to each GPS satellite which is an acquisition target (hereinafter, referred to as an “acquisition target satellite”), performs a process of acquiring the GPS satellite signal, and performs the position calculation using the acquired GPS satellite signal, to thereby calculate the position of the mobile phone 1. The baseband processing will be described in detail later with reference to a flowchart.

The satellite orbit data 272 is data such as an almanac in which schematic satellite orbit information about all GPS satellites is stored, an ephemeris in which detailed satellite orbit information about each GPS satellite is stored, or the like. The satellite orbit data 272 is obtained by decoding the GPS satellite signal received from the GPS satellite, or for example, is obtained as assistance data from a base station of the mobile phone 1 or an assistance server.

The correlation integration time 273 is the time when the correlation values are integrated in order to calculate the integration correlation value used for the acquisition of the GPS satellite signal, and is variably set on the basis of information on the signal strength of the received signal, a reception environment or the like, for example. Details of the setting method of the correlation integration time 273 will be described later. The fact that the correlation integration time which is longer than the bit length (20 milliseconds) of the navigation message data can be set is a significant characteristic of the present embodiment.

The accumulation time 274 is a unit time where the first and second correlation values output from the correlating section 23 are temporarily integrated. The accumulation time 274 may be a time shorter than the correlation integration time 273, and is set to a time of a 1/m multiple (m>1) of the correlation integration time 273, for example.

The correlation value data 275 is data in which the first correlation value output from the first correlator 231 and the second correlation value output from the second correlator 232 are accumulated over the accumulation time 274, respectively. Here, the correlation value data is stored according to the phase of the replica code.

The integration correlation value data 276 is data which respectively stores the first integration correlation value in which the first correlation values accumulated over the accumulation time 274 are integrated and the second integration correlation value in which the second correlation values accumulated over the accumulation time 274 are integrated. Here, the integration correlation value data is stored according to the phase of the replica code.

The combined integration correlation value data 277 is data on the combined integration correlation value used for the acquisition of the GPS satellite signal. Hereinafter, a combined integration correlation value calculated by combining the first integration correlation value and the second integration correlation value in the unit of the accumulation time 274 is defined as a “short-time combined integration correlation value”. On the other hand, a combined integration correlation value obtained by collecting and integrating the short-time combined integration correlation value calculated for each accumulation time 274 over the correlation integration time 273 is defined as a “long-time combined integration correlation value”. Here, the combined integration correlation value data is stored according to the phase of the replica code.

Returning to the functional block in FIG. 5, the host CPU 30 is a processor which generally controls the respective sections of the mobile phone 1 according to a variety of programs such as a system program stored in the storing section 80. The host CPU 30 displays a map which represents a current position on the display section 50 on the basis of the position coordinates output from the baseband processing circuit section 20, or uses the position coordinates for various application processes.

The manipulation section 40 is an input device including, for example, a touch panel, a button switch or the like, and outputs a signal of a pressed key or button to the host CPU 30. Through the manipulation of the manipulation section 40, a variety of instructions such as a call request, a mail transmission/reception request, a position calculation request or the like is input.

The display section 50 includes an LCD (Liquid Crystal Display) or the like, and is a display device which performs various displays based on a display signal input from the host CPU 30. A position display screen, time information or the like is displayed on the display section 50.

The mobile phone antenna 60 is an antenna which performs transmission and reception of wireless signals for a mobile phone through a wireless base station installed by a communication service provider of the mobile phone 1.

The mobile phone wireless communication circuit section 70 is a communication circuit section of the mobile phone including an RF conversion circuit, a baseband processing circuit or the like, and realizes communication or mail transmission/reception by performing modulation and demodulation or the like for the mobile phone wireless signal.

The storing section 80 is a storage device which stores a system program by which the host CPU 30 controls the mobile phone 1, or various programs, data or the like for performing various application processes.

### 2-2. Process Flow

FIG. 7 is a flowchart illustrating a work flow of baseband processing performed in the baseband processing circuit section 20, as the baseband processing program 271 stored in the storing section 27 is read out by the processing section 25.

Firstly, the satellite signal acquiring section 251 performs an acquisition target satellite determination process (step A1). Specifically, at a current time measured by a timepiece (not shown), the satellite signal acquiring section 251 determines a GPS satellite positioned in a predetermined reference position in the sky using the satellite orbit data 272, such as an almanac or an ephemeris stored in the storing section 27, as the acquisition target satellite. For example, in a case of the first position calculation after power supply, the reference position may be set to a position obtained from the assistance server using so-called server assistance. Further, in a case of the second position calculation and thereafter, the reference position may be set to the latest calculation position.

Then, the satellite signal acquiring section 251 performs a process of a loop A with respect to each acquisition target satellite determined in step A1 (steps A3 to A17). In the process of the loop A, the satellite signal acquiring section 251 sets the correlation integration time 273 and the accumulation time 274 with respect to the corresponding acquisition target satellite (step A5).

The setting of the correlation integration time may be realized by various methods. For example, the correlation integration time may be set on the basis of the signal strength of the received GPS satellite signal from the corresponding acquisition target satellite. In general, as the signal strength becomes weaker, it is more difficult to detect the peak of the correlation values if the correlation values are not integrated over a longer time. Thus, the correlation integration time may be preferably set so that the correlation integration time is increased as the signal strength becomes weaker.

Further, the reception environment of the GPS satellite signal may be determined, and then the correlation integration time may be set on the basis of the determined reception environment. For example, in a case where the reception environment is an “indoor environment”, the correlation integration time may be set to a long “1000 milliseconds”, and in a case where the reception environment is an “outdoor environment”, the correlation integration time may be set to a short “200 milliseconds”. These methods of setting the correlation integration time are an example, and may be appropriately changed.

Further, the accumulation time is set to be shorter than the correlation integration time. For example, the correlation integration time may be set to an integer times the time of the accumulation time, or a time of a 1/m multiple (m>1) of the correlation integration time may be set to the accumulation time. The value of “m” can be appropriately determined. For example, in a case where the correlation integration time is set to “1000 milliseconds” and “m=25”, the accumulation time is set to “40 milliseconds”.

Subsequently, the satellite signal acquiring section 251 sets an initial phase of the replica code (step A7). Then, the satellite signal acquiring section 251 outputs an instruction signal which instructs a PRN number of the acquisition target satellite and a phase of the replica code to the replica code generating section 24 (step A9). Further, the satellite signal acquiring section 251 performs the correlation process by reading out the correlation processing program 2711 stored in the storing section 27 (step A11).

FIG. 8 is a flowchart illustrating a work flow of the correlation process.

Firstly, the satellite signal acquiring section 251 accumulates and stores the correlation values output from the first correlator 231 over the accumulation time 274 set in step A5, and integrates the correlation values to thereby calculate the first integration correlation value (step B1). Further, the satellite signal acquiring section 251 accumulates and stores the correlation values output from the second correlator 232 over the accumulation time 274, and integrates the correlated values to thereby calculate the second integration correlation value (step B3).

Then, the satellite signal acquiring section 251 combines the first integration correlation value calculated in step B1 and the second integration correlation value calculated in step B3, to thereby calculate the short-time combined integration correlation value during the accumulation time 274 (step B5). Further, the satellite signal acquiring section 251 adds the calculated short-time combined integration correlation value to the latest long-time combined integration correlation value and updates the combined integration correlation data 277 (step B7).

The satellite signal acquiring section 251 repeats the processes of steps B1 to B7 until the correlation integration time 273 set in step A5 elapses (step B9; No ->step B1). Then, at the time when the correlation integration time 273 elapses (step B9; Yes), the correlation process is terminated.

Returning to the baseband processing in FIG. 7, after performing the correlation process, the satellite signal acquiring section 251 performs the peak detection for the long-time combined integration correlation value stored in the combined integration correlation value data 277 (step A13). If it is determined that no peak is detected (step A13; No), the phase of the replica code is changed (step A15), and then the procedure returns to step A9.

Further, if it is determined that a peak is detected (step A13; Yes), the satellite signal acquiring section 251 transits the process to the next acquisition target satellite. Then, after performing the processes of steps A5 to A15 with respect to all the acquisition target satellites, the satellite signal acquiring section 251 terminates the process of the loop A (step A17).

Then, the position calculating section 253 performs the position calculation using the GPS satellite signal acquired with respect to each acquisition target satellite (step A19). The position calculation may be realized by performing a known convergence operation, for example, using the least-square method or the Kalman filter, on the basis of a pseudo distance between the mobile phone 1 and each acquisition satellite.

The pseudo distance can be calculated as follows. That is, an integer part of the pseudo distance is calculated using the satellite position of the acquisition satellite calculated from the satellite orbit data 272 and the latest calculation position of the mobile phone 1. Further, a fractional part of the pseudo distance is calculated using the phase (code phase) of the replica code corresponding to the peak of the integration correlation values detected in step A13. The pseudo distance can be calculated by summing the integer part and the fractional part which are calculated in this way.

Subsequently, the position calculating section 253 outputs the calculated position (position coordinates) to the host CPU 30 (step A21). Then, the processing section 25 determines whether the process is terminated (step A23). If it is determined that the process is not yet terminated (step A23; No), the procedure returns to step A1. Further, if it is determined that the process is terminated (step A23; Yes), the baseband processing is terminated.

### 2-3. Experimental Result

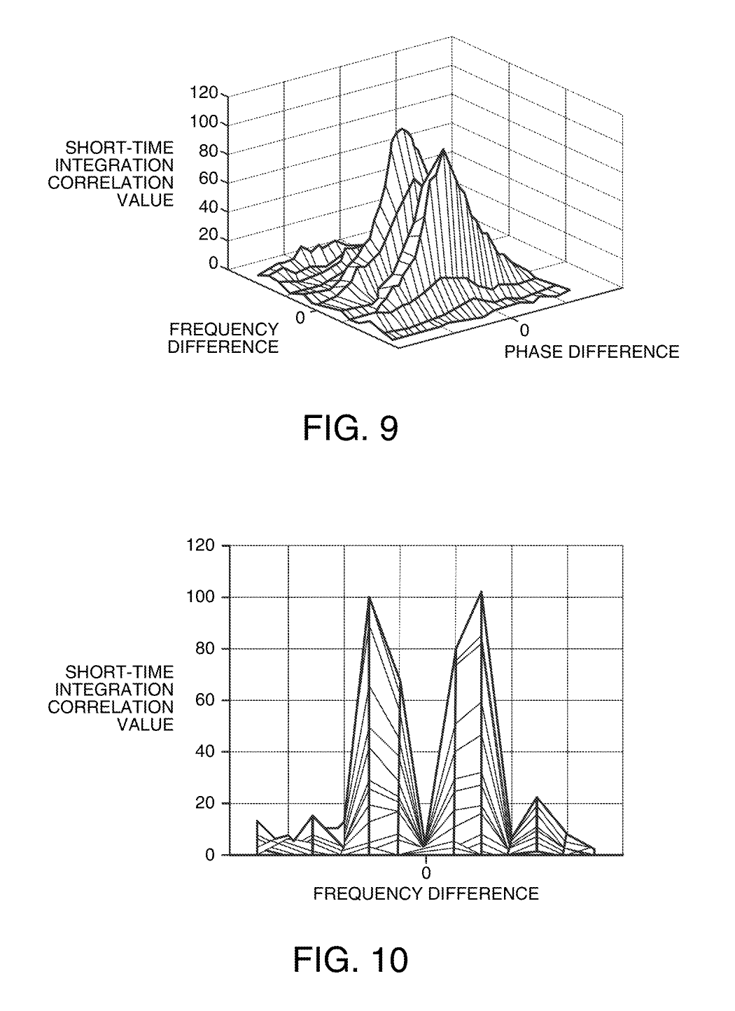

An experimental result in a case where the GPS satellite signal is acquired will be described with reference to FIGS. 9 to 20. The inventor has carried out the experiment under a variety of conditions. Here, an experimental result in which the correlation process is performed using the accumulation time as “40 milliseconds” and the correlation integration time as “1 second (1000 milliseconds)” to thereby acquire the GPS satellite signal will be described as an example.

FIGS. 9 to 14 are diagrams illustrating an example of the experimental result obtained by acquiring the GPS satellite signal according to the correlation processing method in the related art. FIGS. 9 to 11 are diagrams illustrating the experimental result obtained by calculating the integration correlation value (hereinafter, referred to as a “short-time integration correlation value”) obtained by integrating the correlation values corresponding to the accumulation time with respect to each of the frequency direction and the phase direction. Further, FIGS. 12 to 14 are diagrams illustrating the experimental result obtained by calculating the integration correlation value (hereinafter, referred to as a “long-time integration correlation value”) obtained by integrating the short-time integration correlation value calculated with respect to each accumulation time over the correlation integration time.

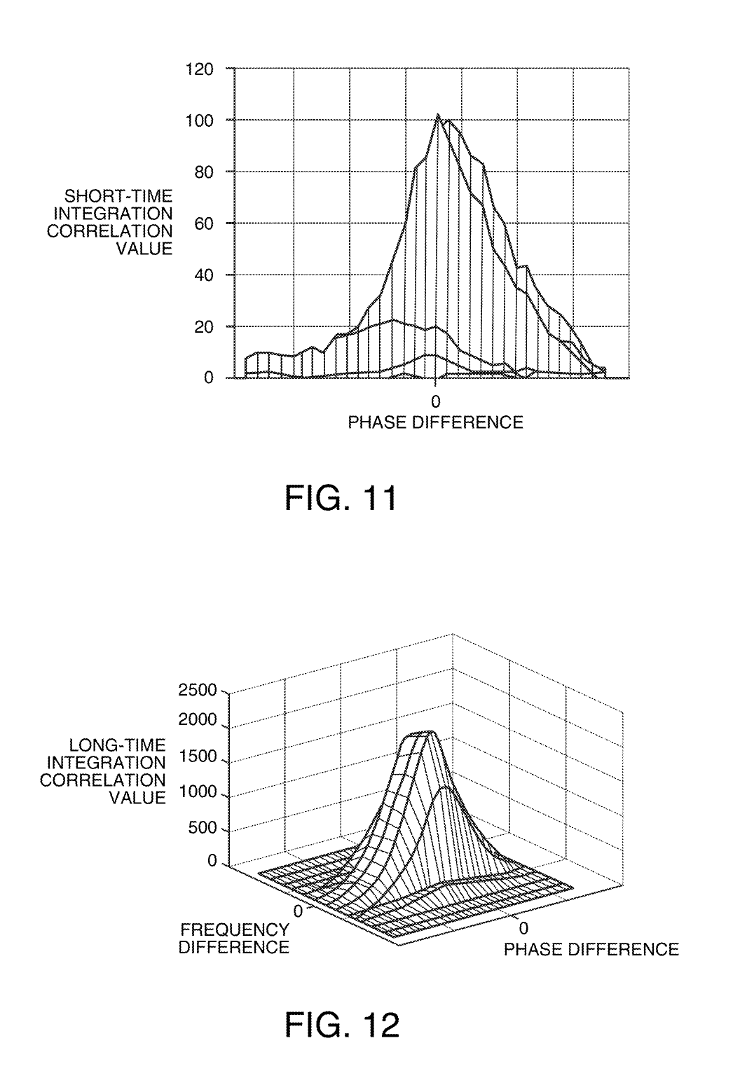

FIG. 9 is a graph illustrating the short-time integration correlation value in the phase direction and the frequency direction in a three-dimensional manner. In FIG. 9, a right depth direction represents a phase difference between a received CA code phase and a replica code phase, and a left depth direction represents a frequency difference (frequency shift) between a received signal frequency and a carrier removal signal frequency. Further, the longitudinal axis represents the short-time integration correlation value. FIG. 10 is a graph illustrating the correlation process result extracted in the frequency direction in FIG. 9, and FIG. 11 is a graph illustrating the correlation process result extracted in the phase direction in FIG. 9.

Referring to the correlation process result in the phase direction in FIG. 11, it can be understood that a peak of the short-time integration correlation value appears in a portion of a phase difference “0”. However, referring to the correlation process result in the frequency direction in FIG. 10, it can be understood that the peak of the short-time integration correlation value does not appear in the portion of the frequency difference “0 Hz” and peaks appear in frequency differences slightly spaced in the left and right directions from “0 Hz”. It has been found out that the frequency differences in which the peaks appear are frequency differences corresponding to “±25 Hz” which is the specific frequency. This is because the frequency components of the specific frequency are included in the correlation values due to the fact that bit inversion of the navigation message data occurs in the period of “40 milliseconds” which is the accumulation time.

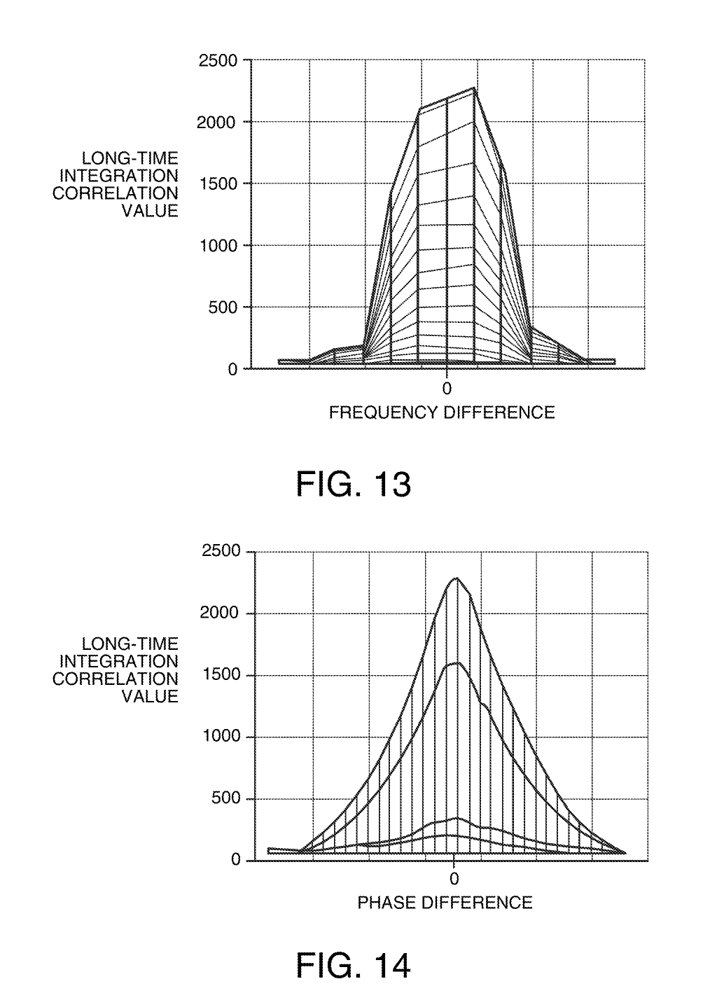

FIG. 12 is a graph illustrating the long-time integration correlation value in the phase direction and the frequency direction in a three-dimensional manner. FIG. 13 is a graph illustrating the correlation process result extracted in the frequency direction in FIG. 12, and FIG. 14 is a graph illustrating the correlation process result extracted in the phase direction in FIG. 12.

Referring to the correlation process result in the phase direction in FIG. 14, it can be understood that a peak of the long-time integration correlation value appears in a portion of a phase difference “0”, in a similar way to the case in FIG. 11. On the other hand, referring to the correlation process result in the frequency direction in FIG. 13, while the peak does not appear in the portion corresponding to “±25 Hz” as shown in FIG. 10, a peak appears in the portion of the frequency difference slightly shifted in the right direction from “0 Hz”, not in the portion of the frequency difference “0 Hz”. It could be understood that the fact that the peak does not appear in the frequency difference “0 Hz” means that the acquisition of the GPS satellite signal fails in the related art.

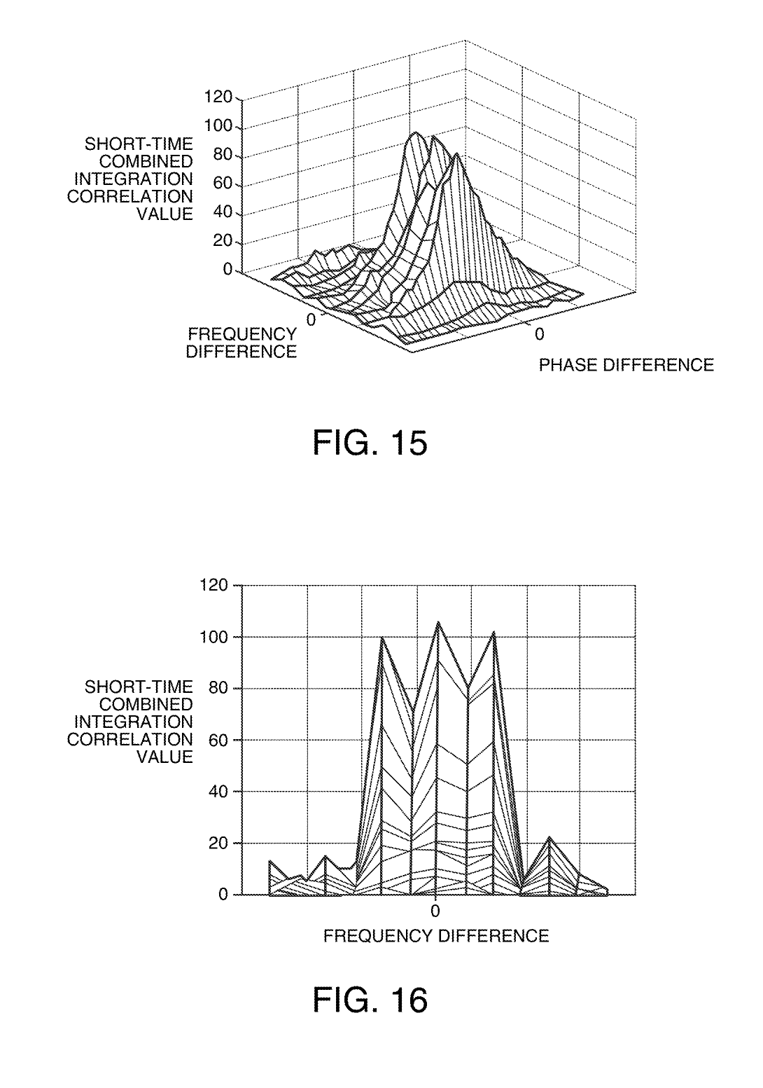

FIGS. 15 to 20 illustrate an example of the experimental result in a case where the GPS satellite signal is acquired according to the correlation operation method in this embodiment. FIGS. 15 to 17 are diagrams illustrating the experimental result where the short-time combined integration correlation value is calculated with respect to each of the frequency direction and the phase direction. Further, FIGS. 18 to 20 are diagrams illustrating the experimental result where the long-time combined integration correlation value is calculated with respect to each of the frequency direction and the phase direction.

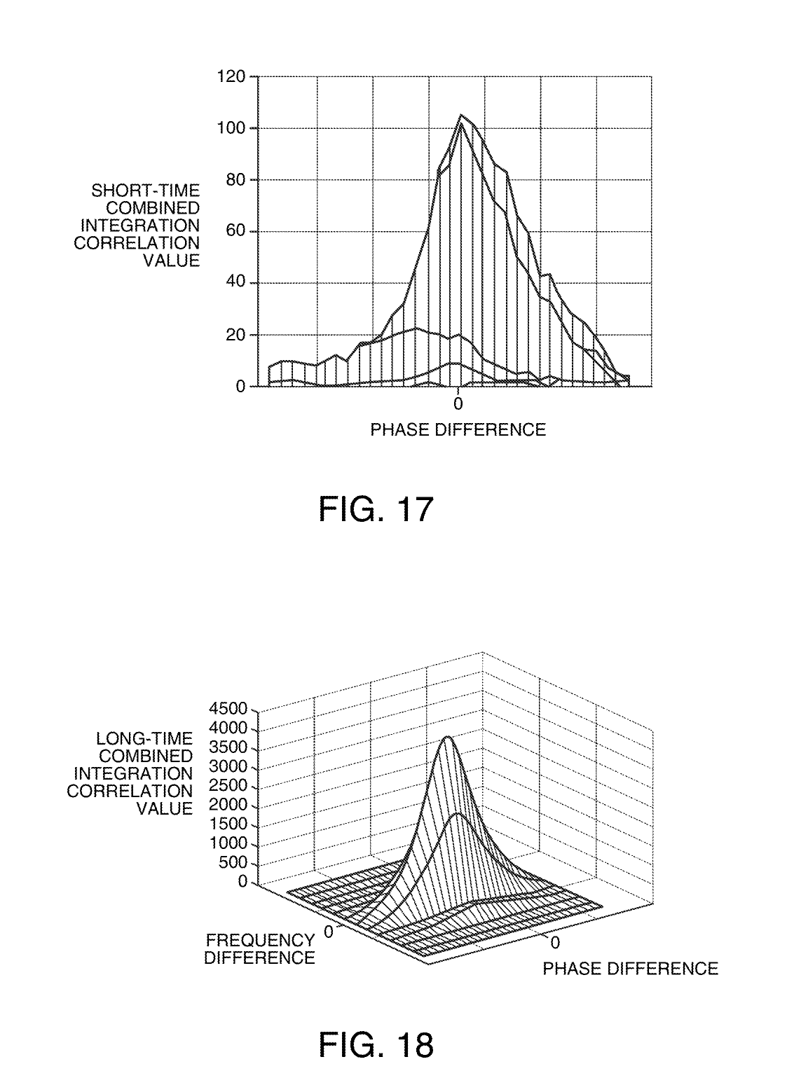

FIG. 15 is a graph illustrating the short-time combined integration correlation value in the phase direction and the frequency direction in a three-dimensional manner. Further, FIG. 16 is a graph illustrating the correlation integration result extracted in the frequency direction in FIG. 15, and FIG. 17 is a graph illustrating the correlation integration result extracted in the phase direction in FIG. 15. The perspective of the graphs is the same as in FIGS. 9 to 11.

Referring to the correlation process result in the phase direction in FIG. 17, it can be seen that a peak of the short-time combined integration correlation value appears in a portion of the phase difference “0”. Further, referring to the correlation process result in the frequency direction in FIG. 16, it can be seen that peaks of the short-time combined integration correlation value appear in three portions such as a portion of the frequency difference “0 Hz”, or portions of the frequency differences corresponding to the specific frequency “±25 Hz”. This is caused by performing a process of combining the integration correlation value (first integration correlation value) corresponding to the specific frequency and the integration correlation value (second integration correlation value) corresponding to the zero frequency. That is, as the extraction result of two kinds of frequency components such as the zero frequency component (direct-current component) and the specific frequency component included in the time change in the correlation values, the peaks appears in the frequency differences corresponding thereto.

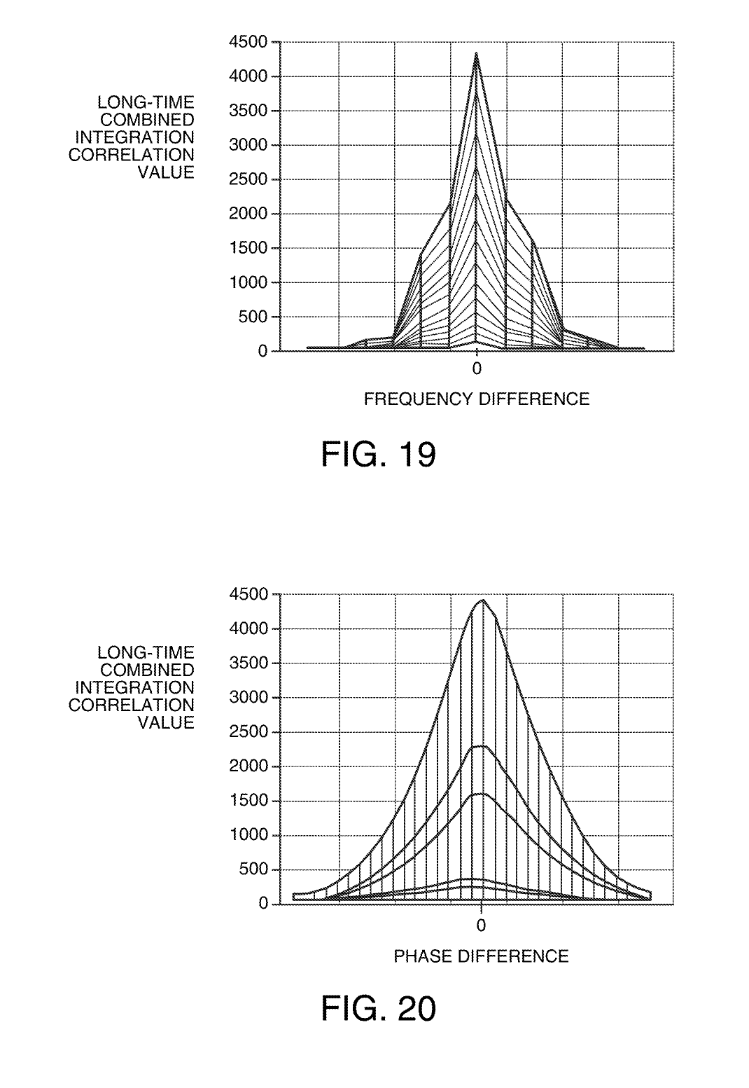

FIG. 18 is a graph illustrating the long-time combined integration correlation value in the phase direction and the frequency direction in a three-dimensional manner. FIG. 19 is a graph illustrating the correlation process result extracted in the frequency direction in FIG. 18, and FIG. 20 is a graph illustrating the correlation process result extracted in the phase direction in FIG. 18. The perspective of the graphs is the same as in FIGS. 12 to 14.

Referring to the correlation process result in the phase direction in FIG. 20, it can be seen that a peak of the long-time combined integration correlation value appears in a portion of a phase difference “0”, in a similar way to the case in FIG. 17. On the other hand, referring to the correlation process result in the frequency direction in FIG. 19, it can be seen that a peak of the long-time combined integration correlation value appears in the portion of the frequency difference “0 Hz”. It can also be understood that the phases and frequencies completely coincide and the acquisition of the GPS satellite signal succeeds according to the present embodiment. In particular, with respect to the correlation process result in the frequency direction, a sharp peak appears in the portion of the frequency difference “0 Hz”, which makes it possible to confirm the effectiveness of the acquisition method of the GPS satellite signal in this embodiment.

### 2-4. Effects

In the baseband processing circuit section 20, the first carrier removal signal generated by the first carrier removal signal generating section 221 is multiplied by the reception signal in the first multiplier 211, and thus, the frequency of the reception signal is converted into the specific frequency. Further, the second carrier removal signal generated by the second carrier removal signal generating section 222 is multiplied by the reception signal in the second multiplier 212, and thus, the frequency of the reception signal is converted into the zero frequency. Further, the correlation operation for the signal of the specific frequency is performed in the first correlator 231 to calculate the first correlation value, and the correlation operation for the signal of the zero frequency is performed in the second correlator 232 to calculate the second correlation value. Then, the integration result of the first correlation value and the integration result of the second correlation value are combined, and the GPS satellite signal is acquired using the combined integration correlation value.

In a case where the correlation process is performed over an arbitrary time equal to or longer than 20 milliseconds which is the bit length of the navigation message data with respect to the reception signal of the GPS satellite signal, even though acquisition is performed according to a correct frequency, it becomes correlation value time-series data having a sign change. However, if acquisition is performed with frequency being shifted by the specific frequency (25 Hz) corresponding to the bit length of the navigation message data, as described in the principle, the correlation value time-series data having a different type of sign change (sign change pattern) of the correlation values due to the presence or absence of the bit inversion of the navigation message data is obtained.

Accordingly, the frequency of the reception signal is converted into the specific frequency and also converted into the zero frequency. Then, if the correlation operation for each converted signal is performed and each correlation value is combined, correlation values having different sign change patterns are overlapped with each other, and thus, it is possible to negate the influence of the bit inversion of the navigation message data. That is, the bit inversion of the navigation message data may be present or absent, but since there is a relationship where one correlation value compensates the other correlation value, it is possible to suppress the influence of the offset of the correlation values having different signs in a case where the correlation values are integrated. Accordingly, it is possible to integrate the correlation values over the arbitrary correlation integration time.

### 3. Modifications

### 3-1. Electronic Devices

In the above-described embodiment, the invention is applied to a mobile phone which is a type of electronic device, but the electronic device to which the invention is able to be applied is not limited thereto. For example, the invention may be similarly applied to other electronic devices such as car navigation devices, mobile navigation devices, personal computers, PDAs (Personal Digital Assistant) or wrist watches.

### 3-2. Position Calculation System

Further, in the above-described embodiment, the GPS is exemplified as the position calculation system, but a position calculation system which uses other satellite positioning systems such as WAAS (Wide Area Augmentation System), QZSS (Quasi Zenith Satellite System), GLONASS (Global Navigation Satellite System), GALILEO, or the like may be employed.

### 3-3. Specific Frequency

In the above-described embodiment, the process is performed using 25 Hz corresponding to the bit length of the navigation message data as the specific frequency, but the process may be performed using other frequencies as the specific frequency.

If the frequency analysis is performed for the correlation value time-series data, although not shown in FIG. 1B, the peak of the power value can also appear in a frequency lower than 25 Hz which is the specific frequency. This is caused by the fact that the bit inversion timing of the navigation message data does not necessarily become the timing every 20 milliseconds. That is, in a case where the bit inversion timing of the navigation message data comes in the period longer than 20 milliseconds, the cycle of the correlation values corresponding to the period does not become 40 milliseconds, but becomes longer than 40 milliseconds. If the cycle becomes longer than 40 milliseconds, the frequency becomes lower than 25 Hz.

For example, in a case where the bit inversion timing of the navigation message data comes at intervals of 40 milliseconds, the cycle of the correlation values corresponding to the interval (period) becomes 80 milliseconds, and the frequency becomes 12.5 Hz. Thus, if a process is performed by adding the frequency (for example, frequency of a 1/n (n>1) multiple of 25 Hz) lower than 25 Hz to the specific frequency, it is possible to accurately perform acquisition of the GPS satellite signal.

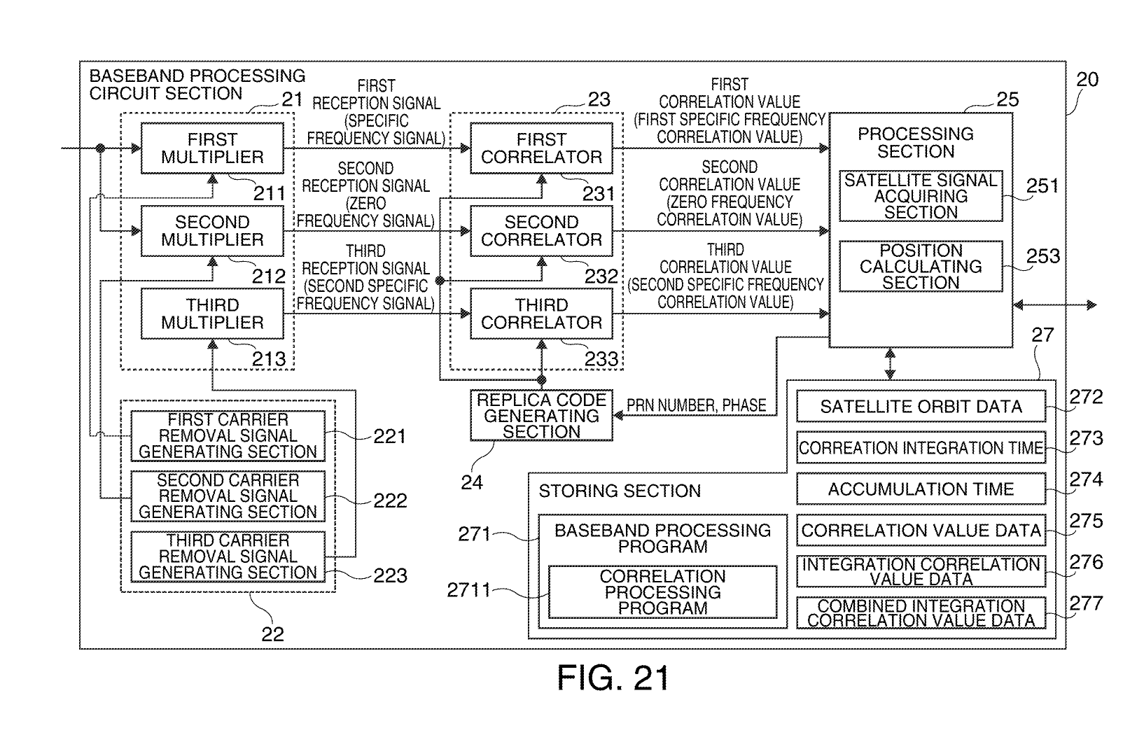

FIG. 21 is a block diagram illustrating an example of a circuit configuration of the baseband processing circuit section 20 in this case. The same reference numerals are given to the same configuration as FIG. 6, and thus, description thereof will be omitted. In the baseband processing circuit section 20 in FIG. 21, there are provided three signal paths, that is, a first signal path in which the frequency of the reception signal is converted into a first specific frequency to perform the correlation operation, a second signal path in which the frequency of the reception signal is converted into the zero frequency to perform the correlation operation, and a third signal path in which the frequency of the reception signal is converted into a second specific frequency to perform the correlation operation. As the specific frequency in this case, for example, the first specific frequency may be set to 25 Hz, and the second specific frequency may be set to 12.5 Hz which is a half thereof.

That is, the first multiplier 211 multiplies the received signal by the first carrier removal signal generated by the first carrier removal signal generating section 221, and down-converts the received signal into the first reception signal (first specific frequency signal) which is the signal of the first specific frequency to thereby output the result to the first correlator 231. The second multiplier 212 multiplies the received signal by the second carrier removal signal generated by the second carrier removal signal generating section 222, and down-converts the received signal into the second reception signal (zero frequency signal) which is the signal of the zero frequency to thereby output the result to the second correlator 232. Then, the third multiplier 213 multiplies the received signal by the third carrier removal signal generated by the third carrier removal signal generating section 223, and down-converts the received signal into the third reception signal (second specific frequency signal) which is the signal of the second specific frequency to thereby output the result to the third correlator 233.

In a case of such a circuit configuration, the processing section 25 combines an integration result (first correlation operation result) of correlation values (first correlation value) of the first specific frequency output from the first correlator 231, an integration result (second correlation operation result) of correlation values (second correlation value) of the zero frequency output from the second correlator 232, and an integration result (third correlation operation result) of correlation values (third correlation value) of the second specific frequency output from the third correlator 233, to thereby acquire the GPS satellite signal using the combined integration correlation value.

A process of installing a k-th multiplier, a k-th carrier removal signal generating section and a k-th correlator (k≧4), and for example, adding the frequency of a 1/n (n>2) multiple of 25 Hz to the specific frequency in a similar way, may be performed.

Further, in the above-described embodiment, the process is performed in consideration of the positive frequency, but the process may be performed in consideration of the negative frequency. In this case, for example, the process may be performed using “−25 Hz” as the specific frequency as described with reference to FIG. 6.

Further, the process may be performed in consideration of both of the positive frequency and the negative frequency. In this case, for example, the first specific frequency as described with reference to FIG. 21 may be set to “+25 Hz”, or the second specific frequency may be set to “−25 Hz”. By considering both of the positive and negative frequencies, it is possible to accurately perform the acquisition of the GPS satellite signal. Of course, in a case where frequencies such as 12.5 Hz or the like other than 25 Hz are used, the negative frequency may be considered in a similar manner.

### 3-4. Acquisition of GPS Satellite Signal

In the above-described embodiment, the result obtained by integrating the correlation operation result for the specific frequency signal is combined by the result obtained by integrating the correlation operation result for the zero frequency signal, to thereby acquire the GPS satellite signal using the combined integration correlation value. However, the combination is merely an example, and for example, the GPS satellite signal may be acquired using the integration result having the large value from among the results obtained by integrating the correlation operation result for the specific frequency signal and the result obtained by integrating the correlation operation result for the zero frequency signal.

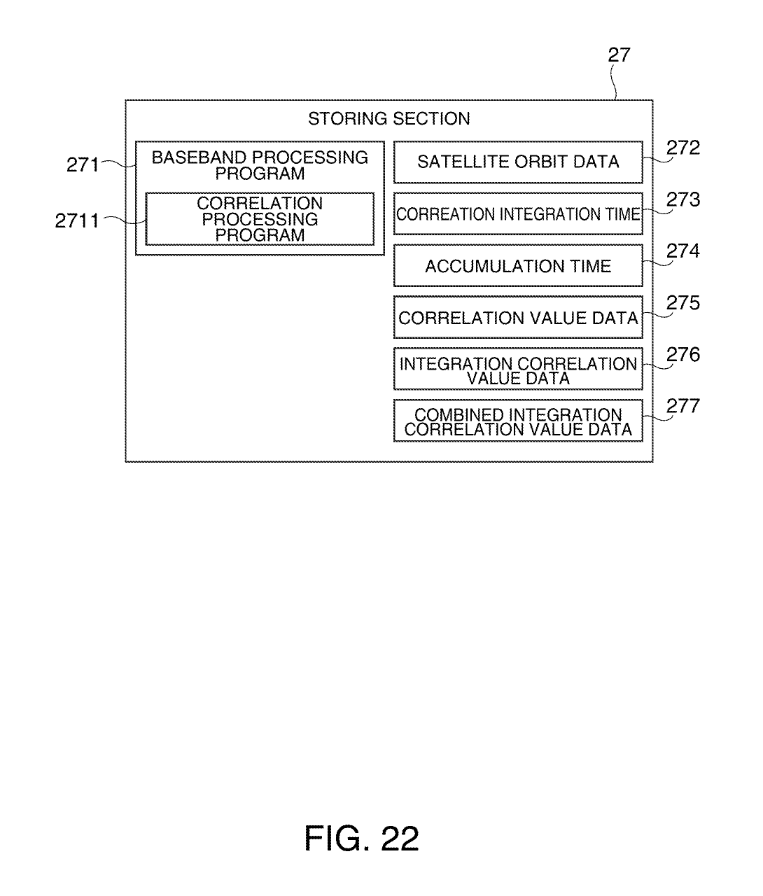

FIG. 22 is a diagram illustrating an example of data stored in the storing section 27 of the baseband processing circuit section 20 in this case. The same reference numerals are given to the same data as in the storing section 27 in FIG. 6, and thus, description thereof will be omitted. In the storing section 27 in FIG. 22, long-time integration correlation value data 278 is stored as data on a first long-time integration correlation value obtained by collecting and integrating the first correlation values calculated over respective accumulation times 274, over a correlation integration time 273, and a second long-time integration correlation value obtained by collecting and integrating the second correlation values calculated over respective accumulation times 274, over the correlation integration time 273.

In this case, the satellite signal acquiring section 251 detects a peak for each long-time integration correlation value stored in the long-time integration correlation value data 278 of the storing section 27. Further, in a case where the peak is detected with respect to any one long-time integration correlation value, the satellite signal acquiring section 251 acquires the GPS satellite signal by detecting the code phase on the basis of the detected peak. Further, in a case where the peak is detected with respect to both the long-time integration correlation values, the satellite signal acquiring section 251 acquires the GPS satellite signal by detecting the code phase using the peak having a larger value.

### 3-5. Accumulation Time

In the above-described embodiment, the short-time combined integration correlation value is calculated for every accumulation, and the long-time combined integration correlation value corresponding to the correlation integration time is calculated by combining these short-time combined integration correlation values. However, the long-time combined integration correlation value may be directly calculated from the correlation values corresponding to the correlation integration time. That is, by respectively integrating the first correlation values and the second correlation values which are accumulated over the correlation integration time to calculate the first integration correlation value and the second integration correlation value and by combining these values, the long-time combined integration correlation value may be calculated.

### 3-6. Conversion and Correlation Operation of Reception Signal

In the above-described embodiment, the conversion of the frequency of the reception signal to the specific frequency or to the frequency zero is performed by the circuit configuration (hardware) in which the reception signal is multiplied by the carrier removal signal, but may be performed by a digital signal process as software. Further, the correlation operation for the specific frequency signal or for the zero frequency signal may be performed by a digital signal process as above, not by the hardware circuit configuration which employs the correlator.

The entire disclosure of Japanese Patent Application No. 2010-067546, filed on Mar. 24, 2010 is expressly incorporated by reference herein.

What is claimed is:

1. A signal acquisition method comprising:
frequency-converting a frequency of a reception signal which is a satellite signal received from a positioning satellite into a specific frequency corresponding to a bit length of navigation message data carried by the satellite signal;
performing a first correlation operation according to a signal of the frequency-converted specific frequency;
integrating results of the first correlation operation over a predetermined time longer than the bit length; and
acquiring the satellite signal using the integrated results.

2. The method according to claim 1, further comprising:
frequency-converting the frequency of the reception signal into a zero frequency;
performing a second correlation operation according to a signal of the frequency-converted zero frequency; and
integrating results of the second correlation operation over the predetermined time,
wherein the satellite signal is acquired using a combination value obtained by combining a result obtained by integrating the results of the first correlation operation and a result obtained by integrating the results of the second correlation operation, in the satellite signal acquisition.

3. The method according to claim 1, further comprising:
frequency-converting the frequency of the reception signal into a zero frequency;
performing a second correlation operation according to a signal of the frequency-converted zero frequency; and
integrating results of the second correlation operation over the predetermined time,
wherein the satellite signal is acquired using any one of a result obtained by integrating the results of the first correlation operation and a result obtained by integrating the results of the second correlation operation, in the satellite signal acquisition.

4. The method according to claim 1,
wherein the specific frequency is 25 Hz.

5. A signal acquisition apparatus comprising:
a receiving section which receives a satellite signal from a positioning satellite;
a frequency converting section which converts a frequency of a reception signal which is received by the receiving section into a specific frequency corresponding to a bit length of navigation message data carried by the satellite signal;
a correlation operating section which performs a correlation operation according to a signal of the specific frequency frequency-converted by the frequency converting section;
an integrating section which integrates results of the correlation operation over a predetermined time longer than the bit length; and
an acquiring section which acquires the satellite signal using the correlation operation results integrated by the integrating section.

6. An electronic device comprising the signal acquisition apparatus according to claim 5.
